(19) United States
(12) Patent Application Publication
(10) Pub. No.: US 2025/0031121 A1
(43) Pub. Date: Jan. 23, 2025

(54) PRIORITIZING HIGH SPEED TRAIN (HST) CELLS OVER NON-HST CELLS

(71) Applicant: QUALCOMM Incorporated, San Diego, CA (US)

(72) Inventors: Xuqiang ZHANG, Beijing (CN); Tom CHIN, San Diego, CA (US); Yongle WU, San Diego, CA (US); Wei-Jei SONG, San Diego, CA (US); Jiming GUO, Beijing (CN); Jun DENG, Shanghai (CN); Hewu GU, Shanghai (CN); Peng HU, Beijing (CN); Jiaheng LIU, Shanghai (CN); Xianwei ZHU, Beijing (CN)

(21) Appl. No.: 18/712,015

(22) PCT Filed: Jan. 5, 2022
(86) PCT No.: PCT/CN2022/070275

§ 371 Date: May 21, 2024

(51) Int. Cl. H04W 36/30; H04W 36/00

(52) U.S. Cl. CPC H04W 36/304; H04W 36/0058; H04W 36/305

(57) ABSTRACT

Various aspects of the present disclosure generally relate to wireless communication. In some aspects, a user equipment (UE) may receive, from a high speed train (HST) cell, a system information block (SIB) indicating an HST flag based at least in part on the UE camping on the HST cell. The UE may disconnect from the HST cell and camping on a non-HST cell based at least in part on a UE mobility in an HST railway. The UE may determine that disconnecting from the non-HST cell and camping on a new HST cell is to be prioritized over remaining on the non-HST cell, based at least in part on the UE being in the HST railway and based at least in part on a priority of HST cells being greater than a priority of non-HST cells. Numerous other aspects are described.

### FIELD OF THE DISCLOSURE

Aspects of the present disclosure generally relate to wireless communication and to techniques and apparatuses for prioritizing high speed train (HST) cells over non-HST cells.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: receive, from a high speed train (HST) cell, a system information block (SIB) indicating an HST flag based at least in part on the UE camping on the HST cell; disconnect from the HST cell and camp on a non-HST cell based at least in part on a UE mobility in an HST railway; and determine that disconnecting from the non-HST cell and camping on a new HST cell is to be prioritized over remaining on the non-HST cell based at least in part on the UE being in the HST railway and based at least in part on a priority of HST cells being greater than a priority of non-HST cells.

In some implementations, a method of wireless communication performed by a UE includes receiving, from an HST cell, a SIB indicating an HST flag based at least in part on the UE camping on the HST cell; disconnecting from the HST cell and camping on a non-HST cell based at least in part on a UE mobility in an HST railway; and determining that disconnecting from the non-HST cell and camping on a new HST cell is to be prioritized over remaining on the non-HST cell, based at least in part on the UE being in the HST railway and based at least in part on a priority of HST cells being greater than a priority of non-HST cells.

In some implementations, a non-transitory computer-readable medium storing a set of instructions for wireless communication includes one or more instructions that, when executed by one or more processors of a UE, cause the UE to: receive, from an HST cell, a SIB indicating an HST flag based at least in part on the UE camping on the HST cell; disconnect from the HST cell and camp on a non-HST cell based at least in part on a UE mobility in an HST railway; and determine that disconnecting from the non-HST cell and camping on a new HST cell is to be prioritized over remaining on the non-HST cell based at least in part on the UE being in the HST railway and based at least in part on a priority of HST cells being greater than a priority of non-HST cells.

In some implementations, an apparatus for wireless communication includes means for receiving, from an HST cell, a SIB indicating an HST flag based at least in part on the apparatus camping on the HST cell; means for disconnecting from the HST cell and camping on a non-HST cell based at least in part on an apparatus mobility in an HST railway; and means for determining that disconnecting from the non-HST cell and camping on a new HST cell is to be prioritized over remaining on the non-HST cell based at least in part on the apparatus being in the HST railway and based at least in part on a priority of HST cells being greater than a priority of non-HST cells.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of high speed train (HST) cells and non-HST cells, in accordance with the present disclosure.

FIG. 4 is a diagram illustrating an example associated with prioritizing HST cells over non-HST cells, in accordance with the present disclosure.

FIG. 5 is a diagram illustrating an example process associated with prioritizing HST cells over non-HST cells, in accordance with the present disclosure.

FIG. 6 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

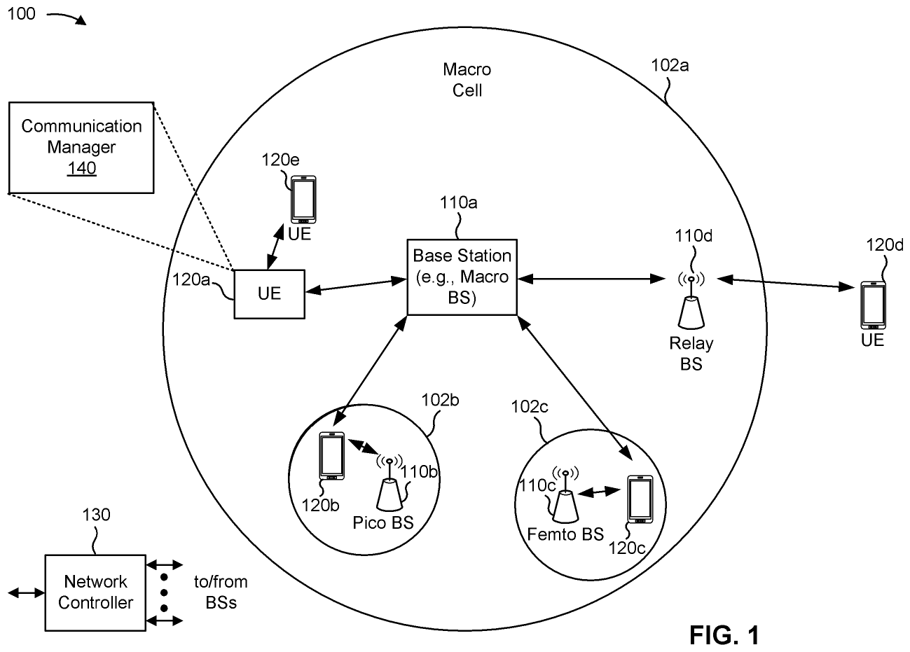

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive, from a high speed train (HST) cell, a system information block (SIB) indicating an HST flag based at least in part on the UE camping on the HST cell; disconnect from the HST cell and camping on a non-HST cell based at least in part on a UE mobility in an HST railway; and determine that disconnecting from the non-HST cell and camping on a new HST cell is to be prioritized over remaining on the non-HST cell, based at least in part on the UE being in the HST railway and based at least in part on a priority of HST cells being greater than a priority of non-HST cells. Additionally, or alternatively, the communication manager 140 may perform one or more other operations described herein.

As indicated above, FIG. 1 is provided as an example. Other examples may differ from what is described with regard to FIG. 1.

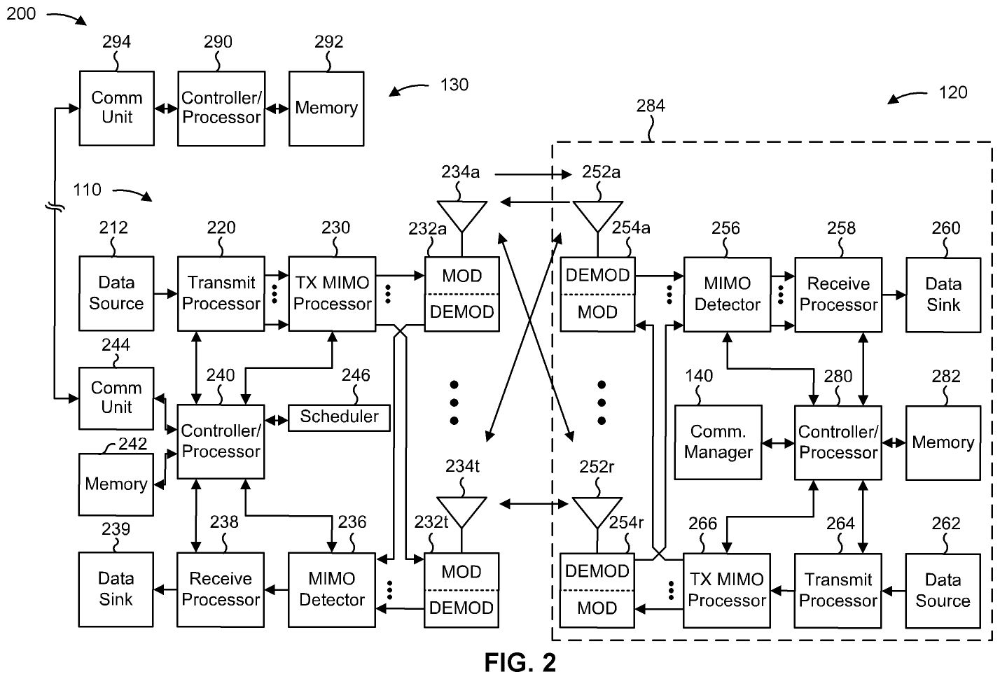

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

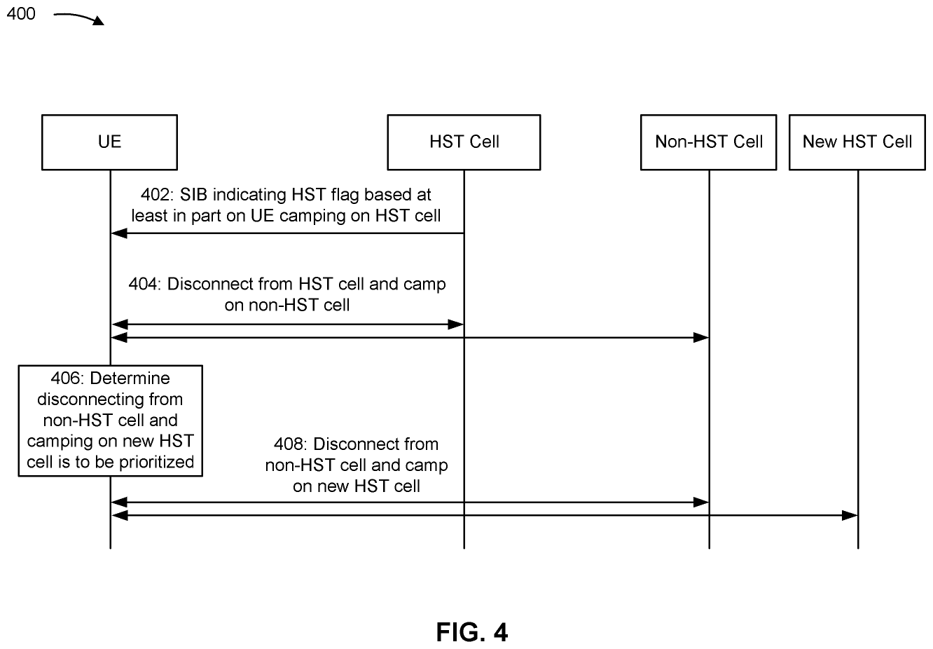

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-6).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-6).

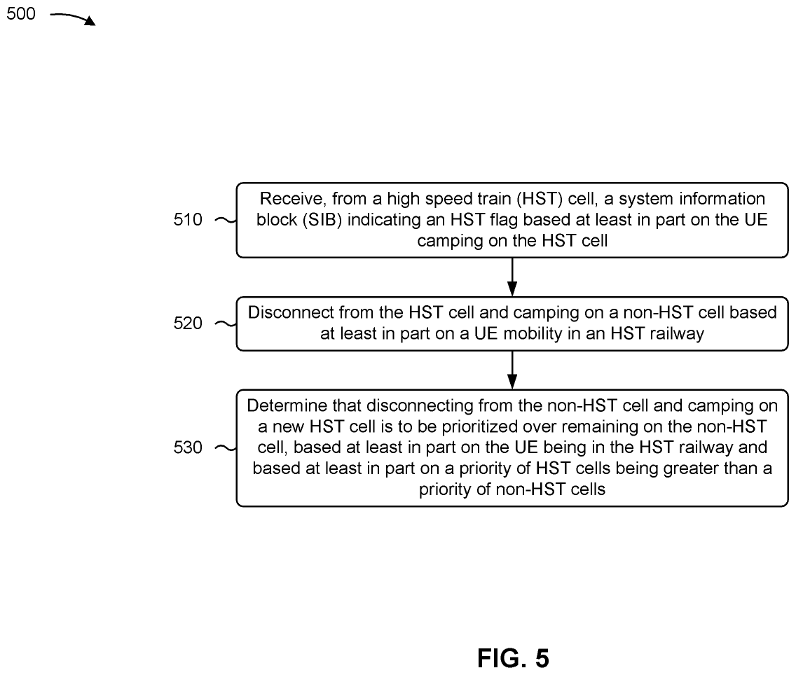

The controller/processor 240 of the base station 110, the controller/processor 280 of the UE 120, and/or any other component(s) of FIG. 2 may perform one or more techniques associated with prioritizing HST cells over non-HST cells, as described in more detail elsewhere herein. For example, the controller/processor 240 of the base station 110, the controller/processor 280 of the UE 120, and/or any other component(s) of FIG. 2 may perform or direct operations of, for example, process 500 of FIG. 5, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, and/or other processes as described herein. In some examples, executing instructions may include running the instructions, converting the instructions, compiling the instructions, and/or interpreting the instructions, among other examples.

In some aspects, a UE (e.g., UE 120) includes means for receiving, from an HST cell, a SIB indicating an HST flag based at least in part on the UE camping on the HST cell; means for disconnecting from the HST cell and camping on a non-HST cell based at least in part on a UE mobility in an HST railway; and/or means for determining that disconnecting from the non-HST cell and camping on a new HST cell is to be prioritized over remaining on the non-HST cell, based at least in part on the UE being in the HST railway and based at least in part on a priority of HST cells being greater than a priority of non-HST cells. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

An HST deployment may provide network connectivity to UEs of passengers onboard an HST running at a relatively high speed (e.g., up to 500 km/hour). An HST railway may be covered by HST cells or non-HST cells (e.g., non-HST macro cells). An HST cell may be a HST dedicated cell that provides better performance as compared to a non-HST cell, in terms of throughput, data latency, and/or handover/reselection success rate.

A UE traveling on the HST railway may receive a SIB from a base station. When the base station is associated with the HST cell, the SIB may include an HST flag. When the base station is associated with the non-HST cell, the SIB may not include the HST flag. The HST cell may indicate the HST flag in the SIB, whereas the non-HST cell may not indicate the HST flag in the SIB. When the SIB received from the base station indicates the HST flag, the UE may enable HST radio resource management (RRM) and demodulation optimizations.

For some network operators, LTE may be covered by non-HST cells, and NR may be covered by HST cells. An HST network may be isolated from a non-HST network. The HST network and the non-HST network may not be configured as neighbor cells. As a result, when the UE camps on a non-HST cell of the non-HST network, the UE may be unable to come back to the HST network and instead may remain on the non-HST cell, which may be disadvantageous for the UE since the HST network may provide better coverage than the non-HST network.

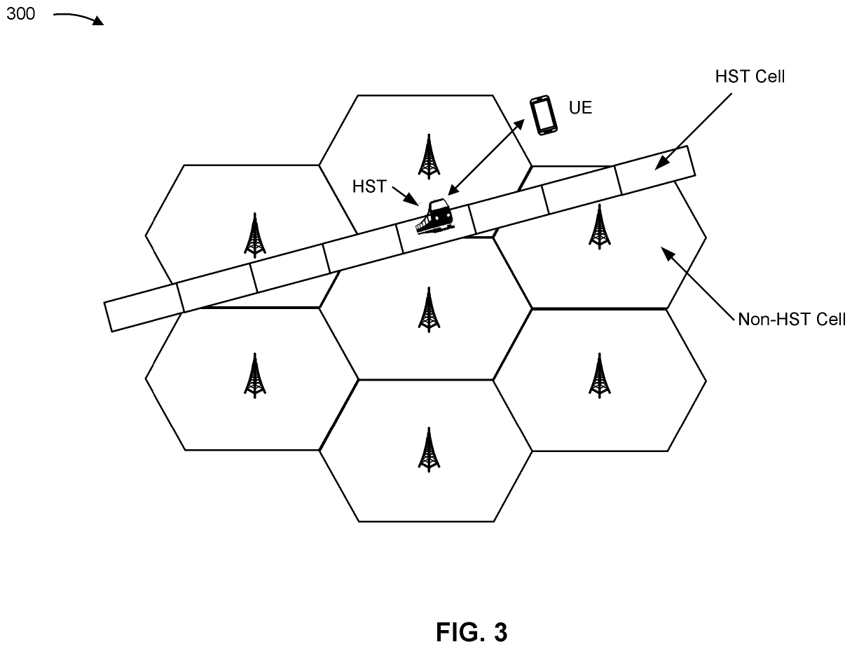

FIG. 3 is a diagram illustrating an example 300 of HST cells and non-HST cells, in accordance with the present disclosure.

As shown in FIG. 3, a UE may be associated with a HST train traveling along an HST railway. For example, a user in the HST train may be carrying the UE, such that the UE may travel along with the HST train in the HST railway. The HST railway may be associated with a plurality of HST cells. An HST cell may provide coverage to the UE in the HST train. The HST cells may be rectangular in shape. The HST cells may be in proximity to or may overlap with non-HST cells. The non-HST cells may be non-HST macro cells that also may provide coverage to the UE in the HST train. The non-HST cells may be associated with a larger coverage area as compared to the HST cells. However, a performance of the non-HST cells in terms of throughput, data rate, and/or a handover or reselection success rate may be inferior to a performance of the HST cells.

In some cases, the UE in the HST train may disconnect from an HST cell and may camp on a non-HST cell. For example, the UE may receive a reference signal from the non-HST cell having a larger RSRP as compared to a reference signal received from the HST cell, which may occur when the UE is temporarily closer to an access point (e.g., base station) associated with the non-HST cell in relation to an access point associated with the HST cell. In this case, the UE in the HST train may disconnect from the HST cell and may camp on the non-HST cell. However, since HST networks may be isolated from non-HST networks, the UE may be unable to connect back to the HST network. Since the HST network may provide a better coverage than the non-HST network, the UE should be able to switch back to the HST network in a minimum amount of time and not unnecessarily be camped on the non-HST network when the HST network is available.

As indicated above, FIG. 3 is provided as an example. Other examples may differ from what is described with regard to FIG. 3.

In various aspects of techniques and apparatuses described herein, a UE may receive, from an HST cell, a SIB indicating an HST flag based at least in part on the UE camping on the HST cell. The UE may disconnect from the HST cell and camp on a non-HST cell based at least in part on a UE mobility in an HST railway. The UE may determine that disconnecting from the non-HST cell and camping on a new HST cell is to be prioritized over remaining on the non-HST cell based at least in part on the UE being in the HST railway and based at least in part on a priority of HST cells being greater than a priority of non-HST cells. In other words, the UE may attempt to camp on the new HST cell (or an original HST cell) within a relatively short period of time instead of remaining on the non-HST, since a coverage associated with the HST cells may be better (e.g., higher throughput, lower latency, and/or higher handover/reselection success rate) than a coverage associated with the non-HST cells, and since connectivity to the HST cells is prioritized over connectivity to the non-HST cells.

FIG. 4 is a diagram illustrating an example 400 associated with prioritizing HST cells over non-HST cells, in accordance with the present disclosure. As shown in FIG. 4, example 400 includes communication between a UE (e.g., UE 120) and a base station (e.g., base station 110). In some aspects, the UE and the base station may be included in a wireless network, such as wireless network 100.

As shown by reference number 402, the UE may receive, from an HST cell, a SIB indicating an HST flag based at least in part on the UE camping on the HST cell. The HST cell may be associated with an HST access point of an HST network. The UE may determine, based at least in part on the SIB indicating the HST flag, that the UE is connected to the HST cell.

As shown by reference number 404, the UE may disconnect from the HST cell and camp on a non-HST cell based at least in part on a UE mobility in an HST railway. The UE mobility may cause a reference signal associated with the HST cell to have a lower RSRP than a reference signal associated with the non-HST cell. As a result, the UE may disconnect from the HST cell and camp on the non-HST cell. The non-HST cell may be associated with a non-HST access point of a non-HST network (e.g., a base station associated with a macro cell).

As shown by reference number 406, the UE may determine that disconnecting from the non-HST cell and camping on a new HST cell is to be prioritized over remaining on the non-HST cell. The UE may determine that disconnecting from the non-HST cell and camping on the new HST cell should be prioritized over remaining on the non-HST cell based at least in part on the UE being in the HST railway and based at least in part on a priority of HST cells being greater than a priority of non-HST cells.

As shown by reference number 408, the UE may disconnect from the non-HST cell and camp on the new HST cell (or an original HST cell) based at least in part on the priority of HST cells being greater than the priority of non-HST cells. As a result, the UE may benefit from improved coverage from the new HST cell in relation to the non-HST cell.

In some aspects, the UE may determine, when the UE is camped on the non-HST cell, that the UE is in the HST railway based at least in part on a timer set after the UE leaves the HST cell. The UE may perform a search for HST cells based at least in part on a determination that the UE is in the HST railway. The UE may camp on the new HST cell based at least in part on the search for HST cells.

In some aspects, the UE may operate in an HST mode when the UE is camped on the non-HST cell, which may enable the UE to return to one of the HST cells. The HST mode may be associated with different parameters as compared to a non-HST mode. The UE may use the different parameters associated with the HST mode, even when camped on the non-HST cell, which may enable the UE to return to one of the HST cells in a shorter period of time as compared to using the non-HST mode to try to find one of the HST cells. In some aspects, when the UE is on the non-HST cell, the UE may operate in the HST mode. The HST mode may be associated with various RRM optimizations, which may assist the UE in returning to one of the HST cell. In other words, the UE may operate in the HST mode even when on the non-HST cell, which may enable the UE to return to one of the HST cells. The UE may use certain sensors or other techniques to assist in HST mode detection (e.g., detecting HST cells when operating in the HST mode).

In some aspects, the UE may detect whether the UE is in the HST railway when the UE camps on the non-HST cell. For example, the UE may receive, from the base station, the SIB with the HST flag when the UE camps on the HST cell. The HST cell may be an HST dedicated cell. The UE may receive the HST flag in an idle state or in a connected state. After leaving the HST cell and camping on the non-HST cell, the UE may set the timer. Before the timer expires and while the UE is on the non-HST cell, when the UE keeps an idle mode cell reselection or connected mode handover relatively frequently (e.g., with a frequency that satisfies a threshold), the UE may assume that the UE is still on the HST railway. The UE may monitor the UE mobility when the UE is in the idle state or in the connected state. The UE may attempt to connect to the HST cell while the timer is running (e.g., prior to expiry of the timer) based at least in part on the idle mode cell reselection or connected mode handover. The UE may prioritize the HST cell over the non-HST cell while on the HST railway.

In some aspects, the HST cells may not be configured as neighbor cells for the non-HST cells. The UE may perform, in the idle mode, a search for HST cells based at least in part on a fingerprint database of HST frequencies and cells, where the search for HST cells may result in an indication of the new HST cell. The UE may disconnect from the non-HST cell and camp on the new HST cell based at least in part on the search and based at least in part on the priority of HST cells being greater than the priority of non-HST cells.

In some aspects, in the idle state, the UE may prioritize the HST network over the non-HST network. When the UE camps on one of the non-HST cells and HST cells are not configured as neighbor cells, the UE may build the fingerprint database for HST frequencies/cells. The UE may perform the search (e.g., a background search) of HST frequencies/fingerprint cells, and the UE may prioritize HST frequencies/cells over non-HST frequencies/cells. When the UE identifies one of the HST cells, the UE may return from the non-HST cell to one of the HST cells. In some aspects, the UE may determine, in the idle mode, that an HST cell quality associated with the new HST cell is greater than a minimum threshold, and that the HST cell quality plus an offset is greater than a cell reselection threshold. The UE may determine to stay connected to the new HST cell based at least in part on the HST cell quality associated with the new HST cell being greater than the minimum threshold, and the HST cell quality plus the offset being greater than the cell reselection threshold.

In some aspects, in the idle state, when the UE camps on the new HST cell, the UE may add the offset to the cell reselection threshold. When the HST cell quality is greater than the minimum threshold, and when the HST cell quality plus the offset is greater than the cell reselection threshold, the UE may stay on the new HST cell and may not move to another non-HST cell. As a result, the new HST cell may be prioritized over other non-HST cells.

In some aspects, the UE may determine, in the connected mode, that an HST cell quality associated with the new HST cell plus an offset is greater than a handover threshold. The UE may determine to not transmit a measurement report for HST cell to non-HST cell handover based at least in part on the HST cell quality plus the offset being greater than the handover threshold. In some aspects, in the connected state, the UE may prioritize the HST network over the non-HST network. When a measurement object is configured between HST cells and non-HST cells, the UE may add the offset to the measurement report. On the new HST cell, when the HST cell quality plus the offset is greater than the handover threshold, the UE may not indicate the measurement report for HST cell to non-HST cell handover. On the non-HST cell, when a non-HST cell quality minus an offset is less than the handover threshold, the UE may indicate the measurement report for non-HST cell to HST cell handover.

In some aspects, the UE may determine, in the connected mode, that a non-HST cell quality associated with the non-HST cell minus an offset is less than a handover threshold. The UE may transmit a measurement report for non-HST cell to HST cell handover based at least in part on the non-HST cell quality minus the offset being less than the handover threshold.

In some aspects, the UE may determine a radio link failure (RLF) or data stall associated with the non-HST cell. The UE may perform a search for HST cells based at least in part on the RLF or data stall. The UE may disconnect from the non-HST cell and camp on the new HST cell based at least in part on the search for HST cells and based at least in part on a measurement object not being configured for handover between the HST cells and the non-HST cells. In some aspects, when the measurement object is not configured for handover between HST cells and non-HST cells, and when a non-HST cell RLF or data stall occurs, the UE may search HST frequencies and autonomously return to one of the HST cells.

In some aspects, the UE mobility in the HST railway may be associated with the idle mode or the connected mode. For either the idle mode or the connected mode, the UE mobility may be based at least in part on mobility between an NR non-HST cell and an NR HST cell, mobility between an LTE non-HST cell and an NR HST cell, mobility between the NR non-HST cell and an LTE HST cell, or mobility between the LTE non-HST cell and the LTE HST cell.

In some aspects, the UE may move between the HST cells and the non-HST cells due to the UE mobility. The UE may move between the HST cells and the non-HST cells since the UE may be onboard the HST. The UE may move between the HST cells and the non-HST cells in the idle more or in the connected mode. In some aspects, idle mode mobility may involve mobility between the NR non-HST cell and the NR HST cell, mobility between the LTE non-HST cell and the NR HST cell, mobility between the NR non-HST cell and the LTE HST cell, or mobility between the LTE non-HST cell and the LTE HST cell. In some aspects, connected mode mobility may involve mobility between the NR non-HST cell and the NR HST cell, mobility between the LTE non-HST cell and the NR HST cell, mobility between the NR non-HST cell and the LTE HST cell, or mobility between the LTE non-HST cell and the LTE HST cell.

As indicated above, FIG. 4 is provided as an example. Other examples may differ from what is described with regard to FIG. 4.

FIG. 5 is a diagram illustrating an example process 500 performed, for example, by a UE, in accordance with the present disclosure. Example process 500 is an example where the UE (e.g., UE 120) performs operations associated with prioritizing HST cells over non-HST cells.

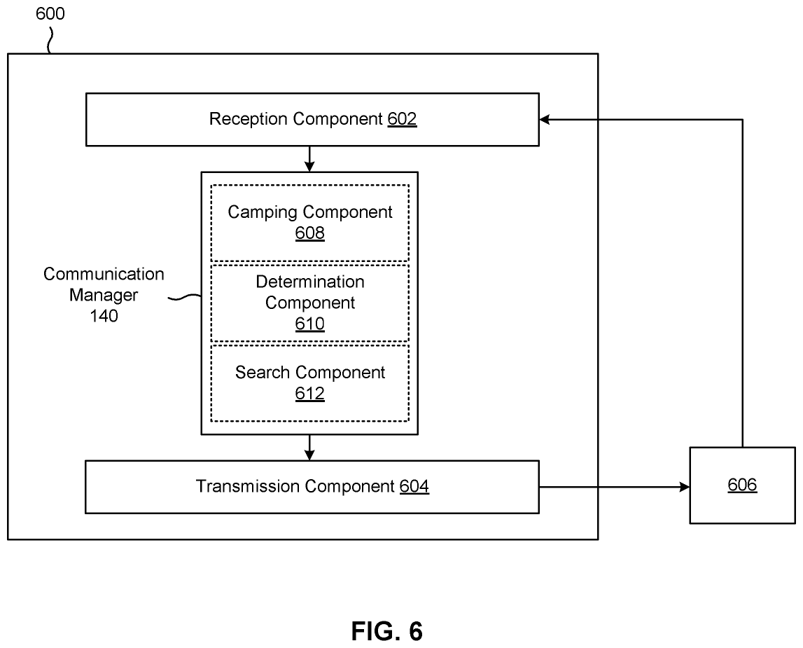

As shown in FIG. 5, in some aspects, process 500 may include receiving, from an HST cell, a SIB indicating an HST flag based at least in part on the UE camping on the HST cell (block 510). For example, the UE (e.g., using communication manager 140 and/or reception component 602, depicted in FIG. 6) may receive, from an HST cell, a SIB indicating an HST flag based at least in part on the UE camping on the HST cell, as described above.

As further shown in FIG. 5, in some aspects, process 500 may include disconnecting from the HST cell and camping on a non-HST cell based at least in part on a UE mobility in an HST railway (block 520). For example, the UE (e.g., using communication manager 140, controller/processor 280, and/or camping component 608, depicted in FIG. 6) may disconnect from the HST cell and camping on a non-HST cell based at least in part on a UE mobility in an HST railway, as described above.

As further shown in FIG. 5, in some aspects, process 500 may include determining that disconnecting from the non-HST cell and camping on a new HST cell is to be prioritized over remaining on the non-HST cell, based at least in part on the UE being in the HST railway and based at least in part on a priority of HST cells being greater than a priority of non-HST cells (block 530). For example, the UE (e.g., using communication manager 140, controller/processor 280, and/or determination component 610, depicted in FIG. 6) may determine that disconnecting from the non-HST cell and camping on a new HST cell is to be prioritized over remaining on the non-HST cell, based at least in part on the UE being in the HST railway and based at least in part on a priority of HST cells being greater than a priority of non-HST cells, as described above.

Process 500 may include additional aspects, such as any single aspect or any combination of aspects described below and/or in connection with one or more other processes described elsewhere herein.

In a first aspect, process 500 includes determining, when the UE is camped on the non-HST cell, that the UE is in the HST railway based at least in part on a timer set after the UE leaves the HST cell; and performing a search for HST cells based at least in part on a determination that the UE is in the HST railway.

In a second aspect, alone or in combination with the first aspect, process 500 includes operating in an HST mode when the UE is camped on the non-HST cell to enable the UE returning to one of the HST cells.

In a third aspect, alone or in combination with one or more of the first and second aspects, the HST cells are not configured as neighbor cells for the non-HST cells, and process 500 further includes performing, in an idle mode, a search for HST cells based at least in part on a fingerprint database of HST frequencies and cells, wherein the search for HST cells results in an indication of the new HST cell; and disconnecting from the non-HST cell and camping on the new HST cell based at least in part on the priority of HST cells being greater than the priority of non-HST cells.

In a fourth aspect, alone or in combination with one or more of the first through third aspects, process 500 includes determining, in an idle mode, that an HST cell quality associated with the new HST cell is greater than a minimum threshold, and that the HST cell quality plus an offset is greater than a cell reselection threshold; and determining to stay connected to the new HST cell based at least in part on the HST cell quality associated with the new HST cell being greater than the minimum threshold, and the HST cell quality plus the offset being greater than the cell reselection threshold.

In a fifth aspect, alone or in combination with one or more of the first through fourth aspects, process 500 includes determining, in a connected mode, that an HST cell quality associated with the new HST cell plus an offset is greater than a handover threshold; and determining to not transmit a measurement report for HST cell to non-HST cell handover based at least in part on the HST cell quality plus the offset being greater than the handover threshold.

In a sixth aspect, alone or in combination with one or more of the first through fifth aspects, process 500 includes determining, in a connected mode, that a non-HST cell quality associated with the non-HST cell minus an offset is less than a handover threshold; and transmitting a measurement report for non-HST cell to HST cell handover based at least in part on the non-HST cell quality minus the offset being less than the handover threshold.

In a seventh aspect, alone or in combination with one or more of the first through sixth aspects, process 500 includes determining an RLF or data stall associated with the non-HST cell; performing a search for HST cells based at least in part on the RLF or data stall; and disconnecting from the non-HST cell and camping on the new HST cell based at least in part on the search for HST cells and based at least in part on a measurement object not being configured for handover between the HST cells and the non-HST cells.

In an eighth aspect, alone or in combination with one or more of the first through seventh aspects, the UE mobility in the HST railway is associated with an idle mode or a connected mode, and the UE mobility is based at least in part on one of mobility between an NR non-HST cell and an NR HST cell, mobility between an LTE non-HST cell and an NR HST cell, mobility between the NR non-HST cell and an LTE HST cell, or mobility between the LTE non-HST cell and the LTE HST cell.

In a ninth aspect, alone or in combination with one or more of the first through eighth aspects, the HST cell is associated with a base station of an HST network, and the non-HST cell is associated with a base station of a non-HST network.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication. The apparatus 600 may be a UE, or a UE may include the apparatus 600. In some aspects, the apparatus 600 includes a reception component 602 and a transmission component 604, which may be in communication with one another (for example, via one or more buses and/or one or more other components). As shown, the apparatus 600 may communicate with another apparatus 606 (such as a UE, a base station, or another wireless communication device) using the reception component 602 and the transmission component 604. As further shown, the apparatus 600 may include the communication manager 140. The communication manager 140 may include one or more of a camping component 608, a determination component 610, or a search component 612, among other examples.

In some aspects, the apparatus 600 may be configured to perform one or more operations described herein in connection with FIG. 4. Additionally, or alternatively, the apparatus 600 may be configured to perform one or more processes described herein, such as process 500 of FIG. 5. In some aspects, the apparatus 600 and/or one or more components shown in FIG. 6 may include one or more components of the UE described in connection with FIG. 2. Additionally, or alternatively, one or more components shown in FIG. 6 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 600. In some aspects, the reception component 602 may include one or more antennas, a modem, a demodulator, a MIMO detector, a receive processor, a controller/processor, a memory, or a combination thereof, of the UE described in connection with FIG. 2.

The transmission component 604 may transmit communications, such as reference signals, control information, data communications, or a combination thereof, to the apparatus 606. In some aspects, one or more other components of the apparatus 600 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, a modem, a modulator, a transmit MIMO processor, a transmit processor, a controller/processor, a memory, or a combination thereof, of the UE described in connection with FIG. 2. In some aspects, the transmission component 604 may be co-located with the reception component 602 in a transceiver.

The reception component 602 may receive, from an HST cell, a SIB indicating an HST flag based at least in part on the UE camping on the HST cell. The camping component 608 may disconnect from the HST cell and camp on a non-HST cell based at least in part on a UE mobility in an HST railway. The determination component 610 may determine that disconnecting from the non-HST cell and camping on a new HST cell is to be prioritized over remaining on the non-HST cell, based at least in part on the UE being in the HST railway and based at least in part on a priority of HST cells being greater than a priority of non-HST cells.

The determination component 610 may determine, when the UE is camped on the non-HST cell, that the UE is in the HST railway based at least in part on a timer set after the UE leaves the HST cell. The search component 612 may perform a search for HST cells based at least in part on a determination that the UE is in the HST railway. The camping component 608 may operate in an HST mode when the UE is camped on the non-HST cell to enable the UE returning to one of the HST cells.

The search component 612 may perform, in an idle mode, a search for HST cells based at least in part on a fingerprint database of HST frequencies and cells, wherein the search for HST cells results in an indication of the new HST cell. The camping component 608 may disconnect from the non-HST cell and camp on the new HST cell based at least in part on the priority of HST cells being greater than the priority of non-HST cells. The HST cells may not be configured as neighbor cells for the non-HST cells.

The determination component 610 may determine, in an idle mode, that an HST cell quality associated with the new HST cell is greater than a minimum threshold, and that the HST cell quality plus an offset is greater than a cell reselection threshold. The determination component 610 may determine to stay connected to the new HST cell based at least in part on the HST cell quality associated with the new HST cell being greater than the minimum threshold, and the HST cell quality plus the offset being greater than the cell reselection threshold.

The determination component 610 may determine, in a connected mode, that an HST cell quality associated with the new HST cell plus an offset is greater than a handover threshold. The determination component 610 may determine to not transmit a measurement report for HST cell to non-HST cell handover based at least in part on the HST cell quality plus the offset being greater than the handover threshold.

The determination component 610 may determine, in a connected mode, that a non-HST cell quality associated with the non-HST cell minus an offset is less than a handover threshold. The transmission component 604 may transmit a measurement report for non-HST cell to HST cell handover based at least in part on the non-HST cell quality minus the offset being less than the handover threshold.

The determination component 610 may determine an RLF or data stall associated with the non-HST cell. The search component 612 may perform a search for HST cells based at least in part on the RLF or data stall. The camping component 608 may disconnect from the non-HST cell and camping on the new HST cell based at least in part on the search for HST cells and based at least in part on a measurement object not being configured for handover between the HST cells and the non-HST cells.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

The following provides an overview of some Aspects of the present disclosure:
Aspect 1: A method of wireless communication performed by a user equipment (UE), comprising: receiving, from a high speed train (HST) cell, a system information block (SIB) indicating an HST flag based at least in part on the UE camping on the HST cell; disconnecting from the HST cell and camping on a non-HST cell based at least in part on a UE mobility in an HST railway; and determining that disconnecting from the non-HST cell and camping on a new HST cell is to be prioritized over remaining on the non-HST cell, based at least in part on the UE being in the HST railway and based at least in part on a priority of HST cells being greater than a priority of non-HST cells.
Aspect 2: The method of Aspect 1, further comprising: determining, when the UE is camped on the non-HST cell, that the UE is in the HST railway based at least in part on a timer set after the UE leaves the HST cell; and performing a search for HST cells based at least in part on a determination that the UE is in the HST railway.
Aspect 3: The method of any of Aspects 1 through 2, further comprising: operating in an HST mode when the UE is camped on the non-HST cell to enable the UE returning to one of the HST cells.
Aspect 4: The method of any of Aspects 1 through 3, wherein the HST cells are not configured as neighbor cells for the non-HST cells, and further comprising: performing, in an idle mode, a search for HST cells based at least in part on a fingerprint database of HST frequencies and cells, wherein the search for HST cells results in an indication of the new HST cell; and disconnecting from the non-HST cell and camping on the new HST cell based at least in part on the priority of HST cells being greater than the priority of non-HST cells.
Aspect 5: The method of any of Aspects 1 through 4, further comprising: determining, in an idle mode, that an HST cell quality associated with the new HST cell is greater than a minimum threshold, and that the HST cell quality plus an offset is greater than a cell reselection threshold; and determining to stay connected to the new HST cell based at least in part on the HST cell quality associated with the new HST cell being greater than the minimum threshold, and the HST cell quality plus the offset being greater than the cell reselection threshold.
Aspect 6: The method of any of Aspects 1 through 5, further comprising: determining, in a connected mode, that an HST cell quality associated with the new HST cell plus an offset is greater than a handover threshold; and determining to not transmit a measurement report for HST cell to non-HST cell handover based at least in part on the HST cell quality plus the offset being greater than the handover threshold.
Aspect 7: The method of any of Aspects 1 through 6, further comprising: determining, in a connected mode, that a non-HST cell quality associated with the non-HST cell minus an offset is less than a handover threshold; and transmitting a measurement report for non-HST cell to HST cell handover based at least in part on the non-HST cell quality minus the offset being less than the handover threshold.
Aspect 8: The method of any of Aspects 1 through 7, further comprising: determining a radio link failure (RLF) or data stall associated with the non-HST cell; performing a search for HST cells based at least in part on the RLF or data stall; and disconnecting from the non-HST cell and camping on the new HST cell based at least in part on the search for HST cells and based at least in part on a measurement object not being configured for handover between the HST cells and the non-HST cells.
Aspect 9: The method of any of Aspects 1 through 8, wherein the UE mobility in the HST railway is associated with an idle mode or a connected mode, wherein the UE mobility is based at least in part on one of: mobility between a New Radio (NR) non-HST cell and an NR HST cell, mobility between a Long Term Evolution (LTE) non-HST cell and an NR HST cell, mobility between the NR non-HST cell and an LTE HST cell, or mobility between the LTE non-HST cell and the LTE HST cell.
Aspect 10: The method of any of Aspects 1 through 9, wherein the HST cell is associated with an access point of an HST network, and wherein the non-HST cell is associated with an access point of a non-HST network.
Aspect 11: An apparatus for wireless communication at a device, comprising a processor; memory coupled with the processor; and instructions stored in the memory and executable by the processor to cause the apparatus to perform the method of one or more of Aspects 1-10.
Aspect 12: A device for wireless communication, comprising a memory and one or more processors coupled to the memory, the one or more processors configured to perform the method of one or more of Aspects 1-10.
Aspect 13: An apparatus for wireless communication, comprising at least one means for performing the method of one or more of Aspects 1-10.
Aspect 14: A non-transitory computer-readable medium storing code for wireless communication, the code comprising instructions executable by a processor to perform the method of one or more of Aspects 1-10.
Aspect 15: A non-transitory computer-readable medium storing a set of instructions for wireless communication, the set of instructions comprising one or more instructions that, when executed by one or more processors of a device, cause the device to perform the method of one or more of Aspects 1-10.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
a memory; and
one or more processors, coupled to the memory, configured to:
receive, from a high speed train (HST) cell, a system information block (SIB) indicating an HST flag based at least in part on the UE camping on the HST cell;
disconnect from the HST cell and camp on a non-HST cell based at least in part on a UE mobility in an HST railway; and
determine that disconnecting from the non-HST cell and camping on a new HST cell is to be prioritized over remaining on the non-HST cell based at least in part on the UE being in the HST railway and based at least in part on a priority of HST cells being greater than a priority of non-HST cells.

2. The apparatus of claim 1, wherein the one or more processors are further configured to:
determine, when the UE is camped on the non-HST cell, that the UE is in the HST railway based at least in part on a timer set after the UE leaves the HST cell; and
perform a search for HST cells based at least in part on a determination that the UE is in the HST railway.

3. The apparatus of claim 1, wherein the one or more processors are further configured to:
operate in an HST mode when the UE is camped on the non-HST cell, to enable the UE returning to one of the HST cells.

4. The apparatus of claim 1, wherein the HST cells are not configured as neighbor cells for the non-HST cells, and wherein the one or more processors are further configured to:
perform, in an idle mode, a search for HST cells based at least in part on a fingerprint database of HST frequencies and cells, wherein the search for HST cells results in an indication of the new HST cell; and
disconnect from the non-HST cell and camp on the new HST cell based at least in part on the priority of HST cells being greater than the priority of non-HST cells.

5. The apparatus of claim 1, wherein the one or more processors are further configured to:
determine, in an idle mode, that an HST cell quality associated with the new HST cell is greater than a minimum threshold, and that the HST cell quality plus an offset is greater than a cell reselection threshold; and
determine to stay connected to the new HST cell based at least in part on the HST cell quality associated with the new HST cell being greater than the minimum threshold, and the HST cell quality plus the offset being greater than the cell reselection threshold.

6. The apparatus of claim 1, wherein the one or more processors are further configured to:
determine, in a connected mode, that an HST cell quality associated with the new HST cell plus an offset is greater than a handover threshold; and
determine to not transmit a measurement report for HST cell to non-HST cell handover based at least in part on the HST cell quality plus the offset being greater than the handover threshold.

7. The apparatus of claim 1, wherein the one or more processors are further configured to:
determine, in a connected mode, that a non-HST cell quality associated with the non-HST cell minus an offset is less than a handover threshold; and
transmit a measurement report for non-HST cell to HST cell handover based at least in part on the non-HST cell quality minus the offset being less than the handover threshold.

8. The apparatus of claim 1, wherein the one or more processors are further configured to:
determine a radio link failure (RLF) or data stall associated with the non-HST cell;
perform a search for HST cells based at least in part on the RLF or data stall; and
disconnect from the non-HST cell and camp on the new HST cell based at least in part on the search for HST cells and based at least in part on a measurement object not being configured for handover between the HST cells and the non-HST cells.

9. The apparatus of claim 1, wherein the UE mobility in the HST railway is associated with an idle mode or a connected mode, and wherein the UE mobility is based at least in part on one of: mobility between a New Radio (NR) non-HST cell and an NR HST cell, mobility between a Long Term Evolution (LTE) non-HST cell and an NR HST cell, mobility between the NR non-HST cell and an LTE HST cell, or mobility between the LTE non-HST cell and the LTE HST cell.

10. The apparatus of claim 1, wherein the HST cell is associated with an access point of an HST network, and wherein the non-HST cell is associated with an access point of a non-HST network.

11. A method of wireless communication performed by a user equipment (UE), comprising:
receiving, from a high speed train (HST) cell, a system information block (SIB) indicating an HST flag based at least in part on the UE camping on the HST cell;
disconnecting from the HST cell and camping on a non-HST cell based at least in part on a UE mobility in an HST railway; and
determining that disconnecting from the non-HST cell and camping on a new HST cell is to be prioritized over remaining on the non-HST cell, based at least in part on the UE being in the HST railway and based at least in part on a priority of HST cells being greater than a priority of non-HST cells.

12. The method of claim 11, further comprising:
determining, when the UE is camped on the non-HST cell, that the UE is in the HST railway based at least in part on a timer set after the UE leaves the HST cell; and
performing a search for HST cells based at least in part on a determination that the UE is in the HST railway.

13. The method of claim 11, further comprising:
operating in an HST mode when the UE is camped on the non-HST cell to enable the UE returning to one of the HST cells.

14. The method of claim 11, wherein the HST cells are not configured as neighbor cells for the non-HST cells, and further comprising:
performing, in an idle mode, a search for HST cells based at least in part on a fingerprint database of HST frequencies and cells, wherein the search for HST cells results in an indication of the new HST cell; and
disconnecting from the non-HST cell and camping on the new HST cell based at least in part on the priority of HST cells being greater than the priority of non-HST cells.

15. The method of claim 11, further
comprising:
determining, in an idle mode, that an HST cell quality associated with the new HST cell is greater than a minimum threshold, and that the HST cell quality plus an offset is greater than a cell reselection threshold; and
determining to stay connected to the new HST cell based at least in part on the HST cell quality associated with the new HST cell being greater than the minimum threshold, and the HST cell quality plus the offset being greater than the cell reselection threshold.

16. The method of claim 11, further
comprising:
determining, in a connected mode, that an HST cell quality associated with the new HST cell plus an offset is greater than a handover threshold; and
determining to not transmit a measurement report for HST cell to non-HST cell handover based at least in part on the HST cell quality plus the offset being greater than the handover threshold.

17. The method of claim 11, further
comprising:
determining, in a connected mode, that a non-HST cell quality associated with the non-HST cell minus an offset is less than a handover threshold; and
transmitting a measurement report for non-HST cell to HST cell handover based at least in part on the non-HST cell quality minus the offset being less than the handover threshold.

18. The method of claim 11, further
comprising:
determining a radio link failure (RLF) or data stall associated with the non-HST cell;
performing a search for HST cells based at least in part on the RLF or data stall; and
disconnecting from the non-HST cell and camping on the new HST cell based at least in part on the search for HST cells and based at least in part on a measurement object not being configured for handover between the HST cells and the non-HST cells.

19. The method of claim 11, wherein the UE mobility in the HST railway is associated with an idle mode or a connected mode, wherein the UE mobility is based at least in part on one of: mobility between a New Radio (NR) non-HST cell and an NR HST cell, mobility between a Long Term Evolution (LTE) non-HST cell and an NR HST cell, mobility between the NR non-HST cell and an LTE HST cell, or mobility between the LTE non-HST cell and the LTE HST cell.

20. The method of claim 11, wherein the HST cell is associated with an access point of an HST network, and wherein the non-HST cell is associated with an access point of a non-HST network.

21. A non-transitory computer-readable medium storing a set of instructions for wireless communication, the set of instructions comprising:
one or more instructions that, when executed by one or more processors of a user equipment (UE), cause the UE to:
receive, from a high speed train (HST) cell, a system information block (SIB) indicating an HST flag based at least in part on the UE camping on the HST cell;
disconnect from the HST cell and camp on a non-HST cell based at least in part on a UE mobility in an HST railway; and
determine that disconnecting from the non-HST cell and camping on a new HST cell is to be prioritized over remaining on the non-HST cell based at least in part on the UE being in the HST railway and based at least in part on a priority of HST cells being greater than a priority of non-HST cells.

22. The non-transitory computer-readable medium of claim 21, wherein the one or more instructions further cause the UE to:
perform, in an idle mode, a search for HST cells based at least in part on a fingerprint database of HST frequencies and cells, wherein the search for HST cells results in an indication of the new HST cell; and
disconnect from the non-HST cell and camp on the new HST cell based at least in part on the priority of HST cells being greater than the priority of non-HST cells.

23. The non-transitory computer-readable medium of claim 21, wherein the one or more instructions further cause the UE to:
determine, in an idle mode, that an HST cell quality associated with the new HST cell is greater than a minimum threshold, and that the HST cell quality plus an offset is greater than a cell reselection threshold; and
determine to stay connected to the new HST cell based at least in part on the HST cell quality associated with the new HST cell being greater than the minimum threshold, and the HST cell quality plus the offset being greater than the cell reselection threshold.

24. The non-transitory computer-readable medium of claim 21, wherein the one or more instructions further cause the UE to:
determine, in a connected mode, that an HST cell quality associated with the new HST cell plus an offset is greater than a handover threshold; and
determine to not transmit a measurement report for HST cell to non-HST cell handover based at least in part on the HST cell quality plus the offset being greater than the handover threshold.

25. The non-transitory computer-readable medium of claim 21, wherein the one or more instructions further cause the UE to:
determine, in a connected mode, that a non-HST cell quality associated with the non-HST cell minus an offset is less than a handover threshold; and
transmit a measurement report for non-HST cell to HST cell handover based at least in part on the non-HST cell quality minus the offset being less than the handover threshold.

26. An apparatus for wireless communication, comprising:
means for receiving, from a high speed train (HST) cell, a system information block (SIB) indicating an HST flag based at least in part on the apparatus camping on the HST cell;
means for disconnecting from the HST cell and camping on a non-HST cell based at least in part on an apparatus mobility in an HST railway; and
means for determining that disconnecting from the non-HST cell and camping on a new HST cell is to be prioritized over remaining on the non-HST cell based at least in part on the apparatus being in the HST railway and based at least in part on a priority of HST cells being greater than a priority of non-HST cells.

27. The apparatus of claim 26, further comprising:
means for performing, in an idle mode, a search for HST cells based at least in part on a fingerprint database of HST frequencies and cells, wherein the search for HST cells results in an indication of the new HST cell; and
means for disconnecting from the non-HST cell and camping on the new HST cell based at least in part on the priority of HST cells being greater than the priority of non-HST cells.

28. The apparatus of claim 26, further comprising:
means for determining, in an idle mode, that an HST cell quality associated with the new HST cell is greater than a minimum threshold, and that the HST cell quality plus an offset is greater than a cell reselection threshold; and
means for determining to stay connected to the new HST cell based at least in part on the HST cell quality associated with the new HST cell being greater than the minimum threshold, and the HST cell quality plus the offset being greater than the cell reselection threshold.

29. The apparatus of claim 26, further comprising:
means for determining, in a connected mode, that an HST cell quality associated with the new HST cell plus an offset is greater than a handover threshold; and
means for determining to not transmit a measurement report for HST cell to non-HST cell handover based at least in part on the HST cell quality plus the offset being greater than the handover threshold.

30. The apparatus of claim 26, further comprising:
means for determining, in a connected mode, that a non-HST cell quality associated with the non-HST cell minus an offset is less than a handover threshold; and
means for transmitting a measurement report for non-HST cell to HST cell handover based at least in part on the non-HST cell quality minus the offset being less than the handover threshold.
